(19) United States
(12) Patent Application Publication
(10) Pub. No.: US 2020/0316983 A1
(43) Pub. Date: Oct. 8, 2020

(54) Sheet of Paper for a Security Document, Method for Producing the Sheet of Paper, and Security Document Produced Therewith

(71) Applicant: OVD Kinegram AG, Zug (CH)

(72) Inventors: Rene Staub, Hagendorn (CH); Fabian Arnold, Zurich (CH)

(21) Appl. No.: 16/303,475

(22) PCT Filed: May 16, 2017
(86) PCT No.: PCT/EP2017/061746

§ 371 Date: Nov. 20, 2018

(30) Foreign Application Priority Data
May 25, 2016 (DE) 102016109654.7

(51) Int. Cl. B42D 25/41; B42D 25/346; B42D 25/351; B42D 25/328; B42D 25/21

(52) U.S. Cl. CPC B42D 25/41; B42D 25/346; B42D 25/21; B42D 25/328; B42D 25/351

(57) ABSTRACT

A sheet for forming a security document includes a carrier substrate and n window elements arranged in window openings of the carrier substrate, wherein n is at least equal to 1 and wherein the n window elements are formed from a window substrate. The n window elements are substance-to-substance bonded to the carrier substrate. Furthermore, a method for producing the sheet is described, as well as a security document which includes the sheet.

The invention relates to a sheet for a security document, a method for producing the sheet and a security document produced therefrom.

Security documents are preferably manufactured from plastic films laminated and/or glued together, which form a sheet from which the security documents are punched out, in particular individually, and which can then be further processed in further method steps. The security documents can, for example, have a card-shaped format, e.g. of an ID1 card or also another format, for example, of a data page of a passport booklet in particular sewn in by means of a hinge. The security documents are, for example, drivers' licenses, passports, bank cards, credit cards, identity cards or the like. To increase the protection against forgery, the security documents can have transparent window areas which can be formed, for example, by omitting a printing or a coating.

EP 2 512 795 B1 describes a method for producing a sheet for a portable data carrier, wherein at least two films are produced by coextrusion, which are formed in each case from at least two different polymer materials and in each case have at least one more highly opaque surface area and one less opaque surface area. The films are arranged one above the other, for example arranged crossed over at 90°, such that the sheet has a graduated opacity with levels of opacity. The relatively laborious production process of the films, wherein the lamination can lead to an undesired deformation of the composite material, is disadvantageous.

The object of the present invention is to specify a sheet which avoids this disadvantage, to specify a method for producing the sheet as well as specifying a security document produced from the sheet.

According to the invention this object is achieved with the subject-matter of claims 1, 24 and 43.

A sheet for forming a security document is proposed, wherein the sheet comprises a carrier substrate and n window elements arranged in window openings of the carrier substrate, wherein n is at least equal to 1 and wherein the n window elements are formed from a transparent window substrate, wherein it is provided that the n window elements are substance-to-substance bonded to the carrier substrate.

By a “substance-to-substance bond” is meant a bond in which the bonding partners are held together by atomic and/or molecular forces. These are indissoluble bonds which can only be separated again by destroying the bonding means or bonding partners. Examples are solder bonds, welded bonds, adhesive bonds, vulcanization bonds.

The sheet according to the invention is a preferably opaque sheet of plastic or plastics with a substantially constant thickness, which contains transparent partial areas. This sheet is a semi-finished product or an intermediate product which, during production by the document producer, can be handled like another document layer or another layer package. The integration, in particular of transparent areas and/or further decorative and/or security elements and/or functional elements into plastics-based documents, in particular card laminates, is thereby simplified.

By “transparent” is meant a transmissivity of more than 50%, preferably more than 70%, further preferably of more than 90% in at least one partial range of the wavelength range visible to the human eye. By “opaque” is meant a transmissivity of less than 20%, preferably less than 5%, further preferably less than 1% in at least one partial range of the wavelength range visible to the human eye.

With the sheet according to the invention, the document producer is able to largely maintain current working procedures in documents production, wherein method steps previously required for forming window areas are omitted.

A further substantial advantage is that, because of the window area, no further distortions occur during lamination of the document, in particular in the transition areas between opaque areas of the carrier substrate and transparent window openings or window elements. In addition, the sheet can be provided with additional features. These features can be applied to the surface of the sheet on one or both sides (printing and/or application of one or more KINEGRAMes®, etc.) and/or lie inside the sheet (printing and/or optical filter, etc.).

The substance-to-substance bonding of the window elements to the carrier substrate prevents window elements being able to be exchanged without destroying the sheet, whereby forgeries are made substantially more difficult.

It can be provided that a continuous transition is formed between the surfaces of the n window elements and the surface of the carrier substrate. In the case of preferred embodiments, the surfaces of the window elements and the surface of the carrier substrate are aligned, whereby a sheet of constant thickness is formed.

It can further be provided that the front and/or the back of the sheet are or is formed with a surface roughness of less than 0.3 μm. In the case of a surface roughness of less than 0.3 μm, a smooth surface, which is particularly well suited for applying transfer plies of transfer films, is present.

It can also be provided that the front and/or the back of the sheet are or is formed with a surface roughness greater than 0.3 μm. In the case of increased surface roughness, the adhesion for printing inks, for example, can be improved.

It can further be provided that the front and/or the back of the sheet are or is formed with a different surface roughness in some areas. It can thereby be made possible, particularly advantageously in some areas to apply a transfer ply of a transfer film to the carrier substrate (in an area of slight surface roughness) or of a print (in an area of greater surface roughness).

In a further advantageous embodiment it can be provided that the front and/or the back of the sheet are or is formed with a surface structure at least in some areas. The surface structure can, for example, improve the tactile or haptic feel and/or have an optical function.

It can be provided that the sheet comprises window elements, the front and/or back of which are or is formed with a lens structure. In this way, so-called tilted images can be produced, for example. So as not to obliterate the lenses when over-laminating with further transparent plastic layers, an optical boundary surface must be created in the form of a difference in refractive index between adjoining materials. These can be adjacent plastics with a different refractive index and/or an in particular transparent reflective layer with a high refractive index (HRI layer; HRI—High Refractive Index).

It can further be provided that the front and/or the back of the sheet are or is formed with markings, in particular with registration marks or register marks. The markings can, for example, facilitate the arrangement of further layers in register and/or, as cutting lines, facilitate the exactly-fitting punching out of the security documents from the sheet. Such markings can, for example, be applied by printing and/or also be present in the form of a change in the surface of the carrier substrate, such as for example a structuring and/or indenting/raising and/or opening and/or a local matting effect.

The sheet can be trimmed. During trimming, the edge of the sheet is cropped to the desired format and the edge of the sheet is brought into the desired shape. This can be effected, for example, by means of a beveled edge and/or by rounding off the edges and corners and/or by introducing a structure into the edge of the sheet (analogous to a knurling).

By “register” or “registration” or “register accuracy” or “registration accuracy” is meant a positional accuracy of two or more elements and/or layers relative to each other. The register accuracy is to vary within a predefined tolerance and to be as low as possible. At the same time, the register accuracy of several elements and/or layers relative to each other is an important feature for increasing the process stability. The positionally accurate positioning can in particular be effected by means of sensory, preferably optically detectable registration marks or register marks. These registration marks or register marks can either represent special separate elements or areas or layers or themselves be part of the elements or areas or layers to be positioned.

The carrier substrate and the window substrate can be formed from the same thermoplastic material and differ, for example, only in the fillers.

However, it can also be provided that the carrier substrate and the window substrate are formed from different plastic material. A different formation can be provided, for example, in order to minimize the use of cost-intensive material.

It can be provided that the carrier substrate and/or the window substrate are or is formed from polycarbonate, polyvinyl chloride, acrylonitrile-butadiene-styrene, Teslin® (matte, white, uncoated single-ply polyethylene film) or polyethylene terephthalate.

In an advantageous embodiment, it can be provided that the carrier substrate is formed opaque. However, the carrier substrate can also be formed translucent, in order to form an optical contrast to the window elements, or be formed with areas of different opacity and/or translucence. It is also possible to form the carrier substrate transparent and to form an edge area, adjoining the window area, opaque or translucent.

The opacity of the carrier substrate can, in particular, be formed by means of fillers. For example, the desired opacity can be adjusted depending on the type of the fillers and/or on the proportion by volume of the fillers. It can be provided that pigments and/or dyes are used as fillers.

The opacity of the carrier substrate can, in particular, be formed by printing with opaque and/or translucent printing inks or varnishes. Such a printing can be effected on one side or on two sides; it can be effected in several steps, i.e. several layers of printing inks or varnishes can be applied over the whole surface or partially overlapping.

The fillers can be formed as pigments and/or as dyes.

In a further advantageous embodiment, it can be provided that the carrier substrate is formed multilayered. The carrier substrate can be formed from layers with different opacity, wherein at least two layers have a different opacity.

The several layers of the carrier substrate can advantageously be pre-stuck, for example by ultrasonic welding, thermal spot welding, partial or extensive gluing or a prelamination, such that, during the production of the window openings, the layers of the carrier substrate do not become displaced relative to each other.

It can also be provided that the carrier substrate has at least one functional layer. Optical effects and/or optically variable effects and/or electronic functions, for example, can thus be integrated into the carrier substrate.

It can also be provided that the carrier substrate has a layer which, by means of laser radiation, can be individualized or personalized, in particular ablated and/or blackened and/or colored.

In an advantageous embodiment, it can be provided that the at least one functional layer comprises an RFID module. By “RFID module” is meant an RFID chip and at least one antenna connected to the RFID chip.

It can also be provided that the window substrate is formed multilayered. The window substrate can be formed from layers with different transparency, wherein at least two layers have a different transparency.

It can further be provided that the window substrate has at least one functional layer. Optical effects and/or optically variable effects and/or electronic functions, for example, can thus be integrated into the window substrate.

The window substrate can, for example, have a fingerprint sensor which identifies the user of the security document.

It can further be provided that the at least one functional layer comprises an optically variable feature. It can, for example, be an optically diffractive feature such as a hologram or a KINEGRAM® and/or an optically variable pigment.

Furthermore, the at least one functional layer can have one or more of the following features:
machine-readable features
printing as over-printing and/or under-printing and/or colored transparent printing and/or mirror-inverted printing
numbering.

It can further be provided that at least one further layer is laminated onto the carrier substrate and/or the window element. This further layer can, for example, form a security feature which is the same for all security documents, for instance identifying the issuer of the security document.

It can be provided that the sheet has a thickness in the range of from 30 μm to 750 μm, preferably a thickness in the range of from 100 μm to 600 μm.

The object of the invention is further achieved with a method for producing a sheet for forming a security document, comprising a carrier substrate and n transparent window elements arranged in the carrier substrate with an n-th outer edge contour, wherein n is at least equal to 1, wherein the following method steps are provided:
a) providing the carrier substrate, which is formed from a thermoplastic material which has a melt phase;
b) forming an i-th through-hole with an i-th inner edge contour which is congruent with an i-th outer edge contour of an i-th window element, in the carrier substrate;
c) providing a window substrate which is formed from a thermoplastic material which has a melt phase;
d) forming the i-th window element;
e) inserting the I-th window element into the i-th through-hole;
f) repeating method steps b) to e) up to i=n in order to form the sheet;
g) placing the sheet in a laminating press, wherein the laminating press has an upper stamp and a lower stamp between which a pressing pressure can be formed, and laminating the sheet at a temperature above the melt phases of the carrier substrate and of the window substrate.

By “congruent” is meant that the window element is approximately identical in shape with the through-hole. The discrepancy between the respective edge contours of window element and through-hole is to be a maximum of 0.5 mm, preferably a maximum of 0.25 mm. This means that the dimensions of the window element and of the through-hole differ by a maximum of 1 mm, preferably a maximum of 0.5 mm. It is preferred if the circumference of the window element is approximately 0.5 mm, preferably approximately 0.25 mm smaller than the associated through-hole. This means that the dimensions of the window element are to be a maximum of 1 mm, preferably a maximum of 0.5 mm, smaller than the dimensions of the through-hole.

With the method according to the invention, a sheet is produced which is formed as an opaque sheet with a substantially constant thickness and contains transparent partial areas. This sheet is a semi-finished product or an intermediate product which, during production by the document producer, can be handled like another document layer or another layer package. The integration, in particular of transparent areas and/or further decorative and/or security elements and/or functional elements in plastics-based documents, in particular card laminates, is thereby simplified.

Further layers and/or printings are applied to the sheet by the producer of security documents, for example in order to individualize and/or personalize the security document. The sheet has n sections which can in each case be completed to form a security document and are delimited from each other, for example, by cutting lines or punching lines. Thus, for example, card-shaped security documents can be produced from the sheet, which are obtained by separating or punching out or by laser cutting of the sheet formed with the further layers, for example, along or using the cutting lines. After this separation of the security documents, the separated security documents and the residual material are present as a grid.

With the method according to the invention it is possible to integrate method steps which have hitherto been performed by the producer of the security document, into the production of the sheet.

A further substantial advantage is that, because of the substance-to-substance bonded window area, no further distortions occur locally in the transition areas during lamination of the document. In addition, the sheet can be provided with additional features. These features can be applied to the surface of the sheet on one or both sides (printing, application of one or more KINEGRAMs®, etc.) or lie inside the sheet (printing, optical filters, etc.).

The substance-to-substance bonding of the window elements to the carrier substrate prevents window elements being able to be exchanged without destroying the sheet, whereby forgeries are made substantially more difficult.

In order to form the sheet, the window openings are formed in the carrier substrate, for example by
punching (with punch and die, closed punching knife, or similar);
cutting (knife, water jet, etc.);
lasers;
milling;
a chemical process.

The window elements are produced from the window substrate by
punching (with punch and die, closed punching knife, or similar);
cutting (knife, water jet, etc.);
lasers;
milling;

and, in a subsequent method step, are inserted into the window openings of the carrier substrate.

The position tolerances of the window openings in the sheet depend on the production process of the opening, the lamination and the post-processing. As has been determined by means of tests, the following tolerances are preferably to be observed:

window opening: +/−0.5 mm

lamination: +/−0.5 mm (The distortion can optionally be compensated for, if it is reproducible)

post-processing (edge trimming, position mark, position punching relative to the window openings: +/−0.5 mm

total: +/−1.5 mm

The window openings can be formed with minimum corner radii of 0.5 mm.

The size of the window opening is limited on the one hand by the size of the security document and on the other hand by the smallest producible window opening. The term “size” refers to the surface area which, for example, in the case of rectangular window openings, corresponds to the product of width and height of the window opening. As tests have shown, the size of the window opening must be greater than 0.1 mm². The size of the window openings preferably lies in the range of from 7 mm² to 700 mm².

Ideal window openings have a rectangular cross section with vertical cut edges. In this case the cut edges have an angle of inclination of 90° to the surface of the carrier substrate. The angle of inclination of the cut edges can lie in the range of from 60° to 120°, preferably in the range of from 70° to 110°. The cross section can be formed trapezoidal or rhombic.

In a further method step, the window elements are connected to the carrier substrate by lamination. The window elements and the carrier substrate thereby enter into a substance-to-substance bond which cannot be separated non-destructively. Here, a softening temperature, which depends on the materials used, must be exceeded. In the case of polycarbonate, a temperature of approximately 150° C. must be exceeded and a surface pressure greater than 10 N/cm² must be applied.

The lamination is carried out in a heated laminating press, wherein the carrier substrate fitted with the window elements is in each case laid between two heated lamination plates which, when the laminating press is closed, exert a pressing pressure on the carrier substrate and the window elements, with the result that a sheet with a constant thickness is formed. After the lamination, the sheet has a thickness reduced by 5% to 10% relative to the unprocessed carrier substrate. On average, the thickness is reduced by approximately 8%. The loss of thickness results from the melting of different surfaces and the smoothing of the roughness of the starting materials typically used, and only to a very small extent from the flowing of the material in the press.

Packages of a plurality of sheets and associated lamination plates are usually placed in the laminating press, in order to be able to process the greatest possible number of sheets in one laminating procedure. For example, 10 sheets and for each sheet a lamination plate, in each case above and below the individual sheet, i.e. 11 lamination plates, are placed in the laminating press. The press stamps of the laminating press then act on this package.

Instead of a flat lamination of the whole sheet, the individual window elements can also be substance-to-substance bonded to the sheet by other methods. Thus, the edge area of the window elements can be joined to the carrier substrate by means of ultrasound. Here, a sonotrode is guided along the edge areas or a sonotrode adapted to the outer contour of the window elements is used. It is also possible to carry out the substance-to-substance bonding only in partial areas of the outer contour.

It is further possible to produce the substance-to-substance bond by means of a heated stamp which is larger than the window element. The stamp then locally laminates the window element into the carrier substrate of the sheet. Either several suitably arranged stamps are used or the stamp is moved relative to the sheet.

Furthermore, the substance-to-substance bond can also be produced by applying an adhesive. An acrylate adhesive, or also a plastic, for example polycarbonate, dissolved in a solvent, can be used as adhesive, for example. Furthermore, molten plastic, which is for example suitably applied by means of a dispenser, can also serve as adhesive. In the cases described above, a further lamination to form a semi-finished product is no longer necessary, as the window elements are already substance-to-substance bonded to the carrier substrate of the sheet.

During lamination the surface roughness of the lamination plates is transferred to the surfaces of the sheet. The surface roughness of the sheet is therefore determined by the surface roughness of the lamination plates. While solidifying in the cooling phase, the thermoplastic material takes on the surface roughness of the lamination plates used. It can also be provided, not only to adjust the surface roughness but also to form local surface structures and/or markings in the sheet in a targeted manner.

It can be provided that the lamination plates of the laminating press above and/or below the sheet are or is formed as an embossing stamp at least in some areas. In this way markings, for example, can be embossed into the sheet.

It can further be provided that method steps a) and b) and method steps c) and d) are performed independently of each other.

It can further be provided that, after the lamination, the edges of the “sheet” are post-processed and the sheet is trimmed to the desired size. Furthermore, it can be provided that, during further processing, openings, such as for example positioning holes, are introduced for simplified precisely registered positioning.

It can be provided that, before method step g), at least one further layer is applied to the carrier substrate and/or the window element. This further layer can, for example, form a printing and/or a security feature and/or a functional feature which is the same for all security documents, for instance identifying the issuer of the security document.

The sheet can be formed with a thickness in the range of from 30 μm to 750 μm, preferably be formed with a thickness in the range of from 100 μm to 600 μm.

The object of the invention is further achieved with a security document which comprises a sheet as described further above.

The invention is now explained in more detail with reference to embodiment examples. There are shown in

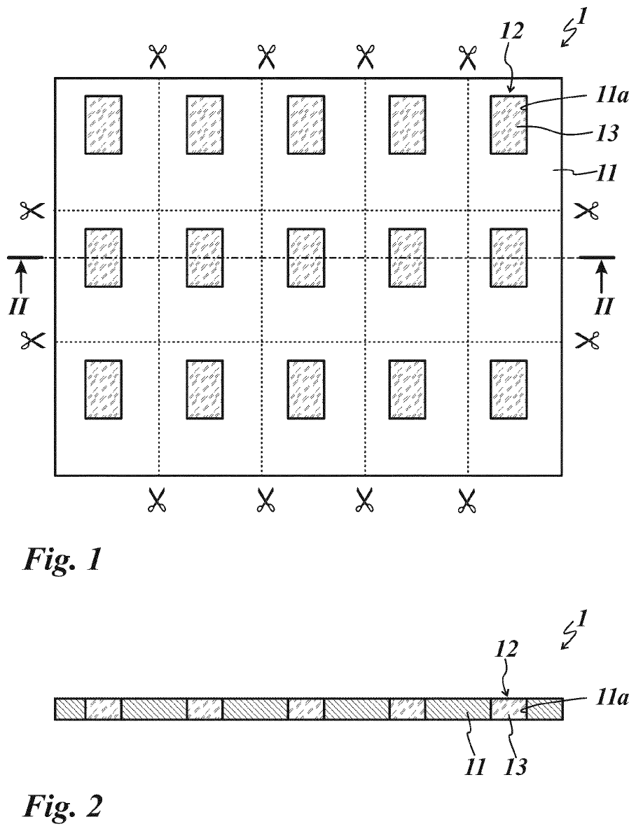

FIG. 1 a first embodiment example of the sheet according to the invention in a schematic top view;

FIG. 2 a sectional view of the sheet along the section line II-II in FIG. 1;

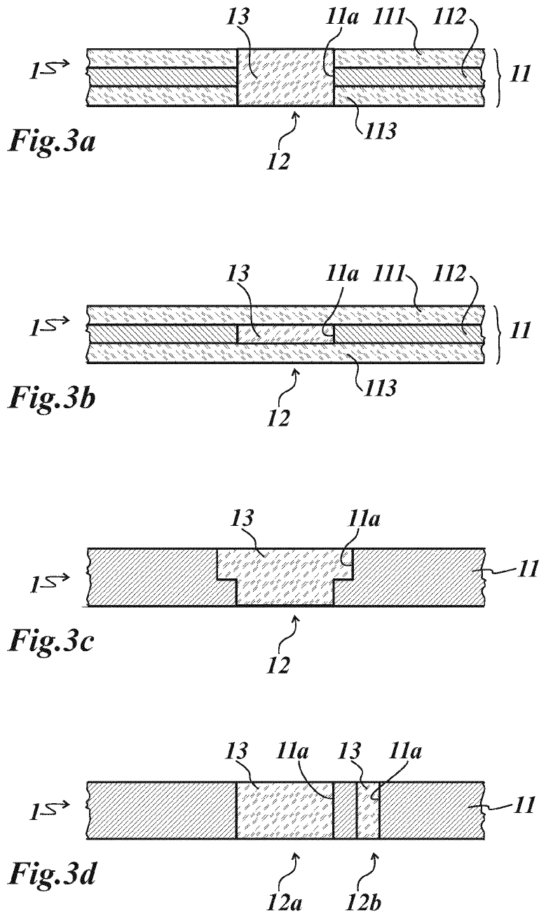

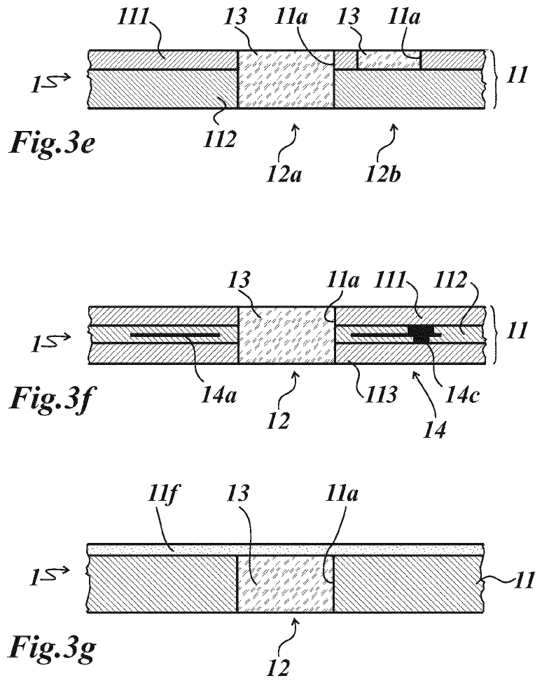

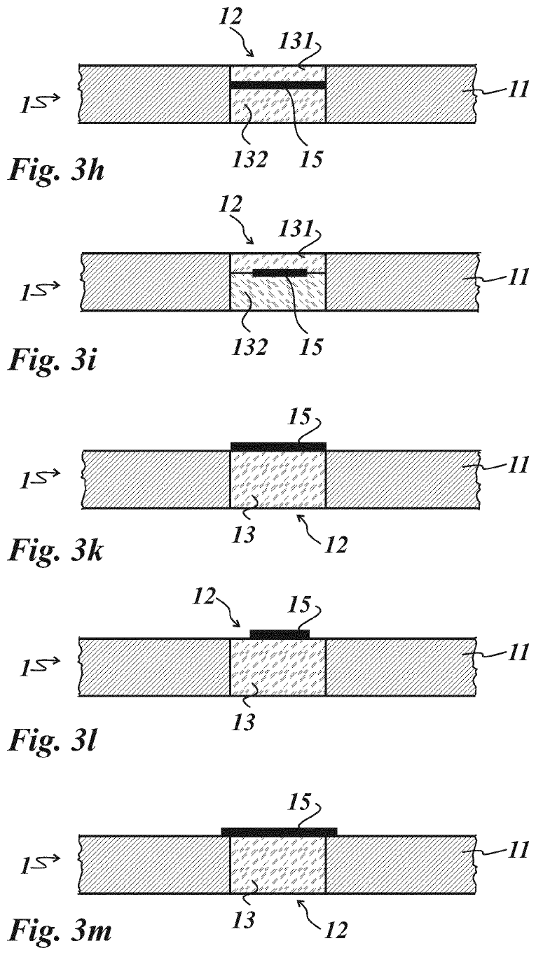

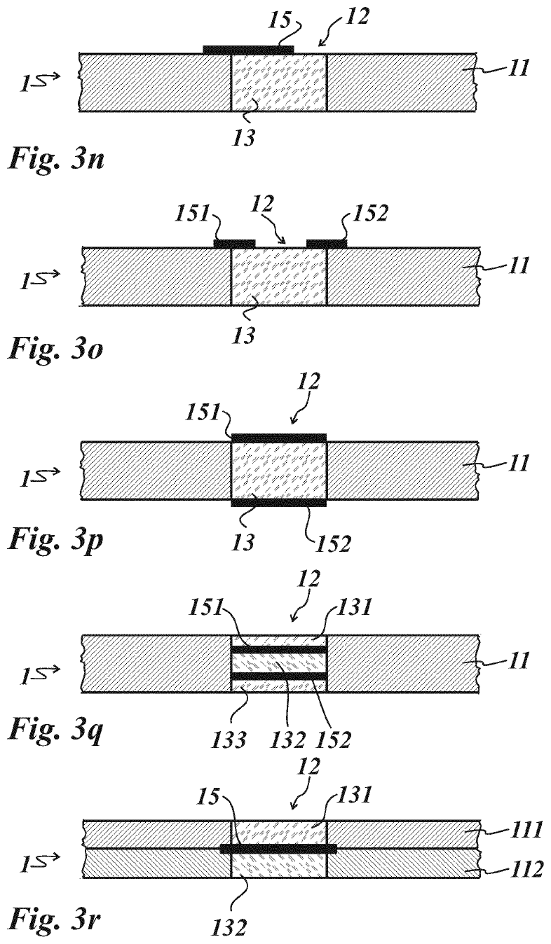

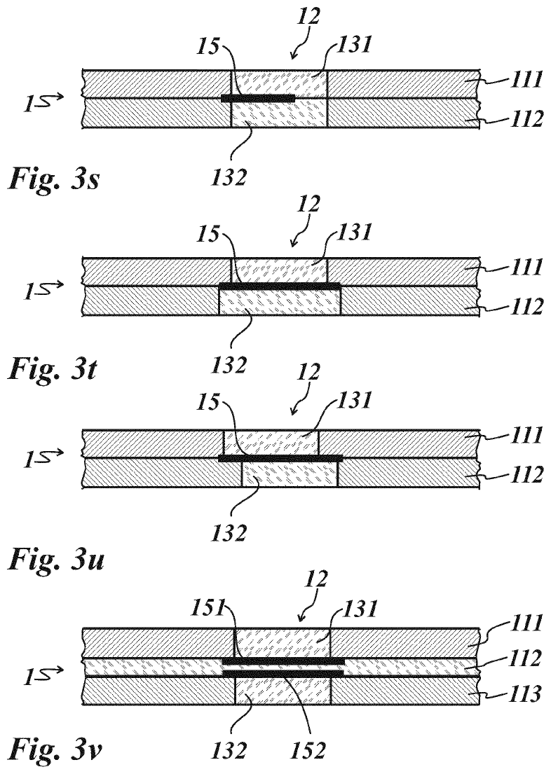

FIG. 3a a second embodiment example of the sheet according to the invention in a schematic sectional view;

FIG. 3b a third embodiment example of the sheet according to the invention in a schematic sectional view;

FIG. 3c a fourth embodiment example of the sheet according to the invention in a schematic sectional view;

FIG. 3d a fifth embodiment example of the sheet according to the invention in a schematic sectional view;

FIG. 3e a sixth embodiment example of the sheet according to the invention in a schematic sectional view;

FIG. 3f a seventh embodiment example of the sheet according to the invention in a schematic sectional view;

FIG. 3g an eighth embodiment example of the sheet according to the invention in a schematic sectional view;

FIG. 3h a ninth embodiment example of the sheet according to the invention in a schematic sectional view;

FIG. 3i a tenth embodiment example of the sheet according to the invention in a schematic sectional view;

FIG. 3k an eleventh embodiment example of the sheet according to the invention in a schematic sectional view;

FIG. 3l a twelfth embodiment example of the sheet according to the invention in a schematic sectional view;

FIG. 3m a thirteenth embodiment example of the sheet according to the invention in a schematic sectional view;

FIG. 3n a fourteenth embodiment example of the sheet according to the invention in a schematic sectional view;

FIG. 3o a fifteenth embodiment example of the sheet according to the invention in a schematic sectional view;

FIG. 3p a sixteenth embodiment example of the sheet according to the invention in a schematic sectional view;

FIG. 3q a seventeenth embodiment example of the sheet according to the invention in a schematic sectional view;

FIG. 3r an eighteenth embodiment example of the sheet according to the invention in a schematic sectional view;

FIG. 3s a nineteenth embodiment example of the sheet according to the invention in a schematic sectional view;

FIG. 3t a twentieth embodiment example of the sheet according to the invention in a schematic sectional view;

FIG. 3u a twenty-first embodiment example of the sheet according to the invention in a schematic sectional view;

FIG. 3v a twenty-second embodiment example of the sheet according to the invention in a schematic sectional view;

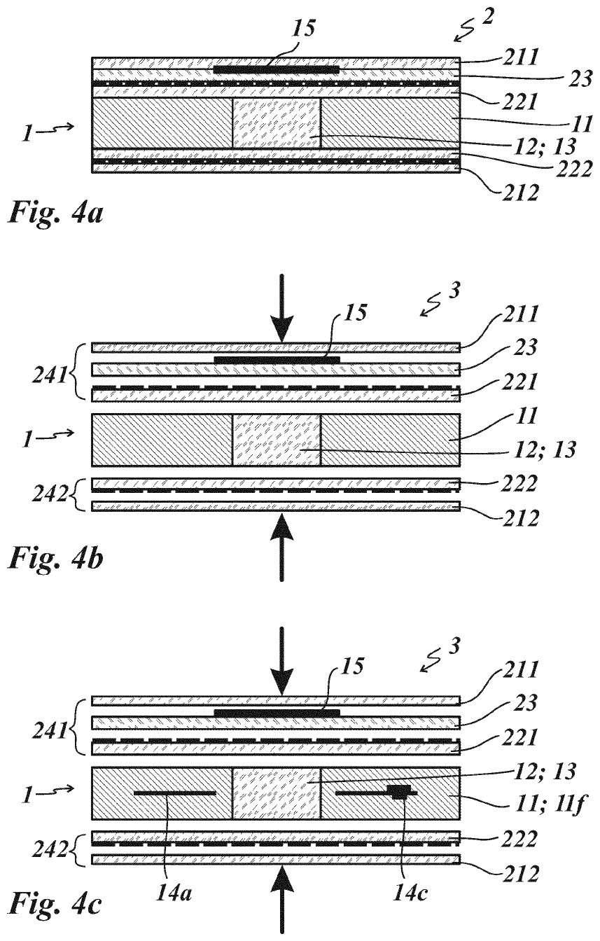

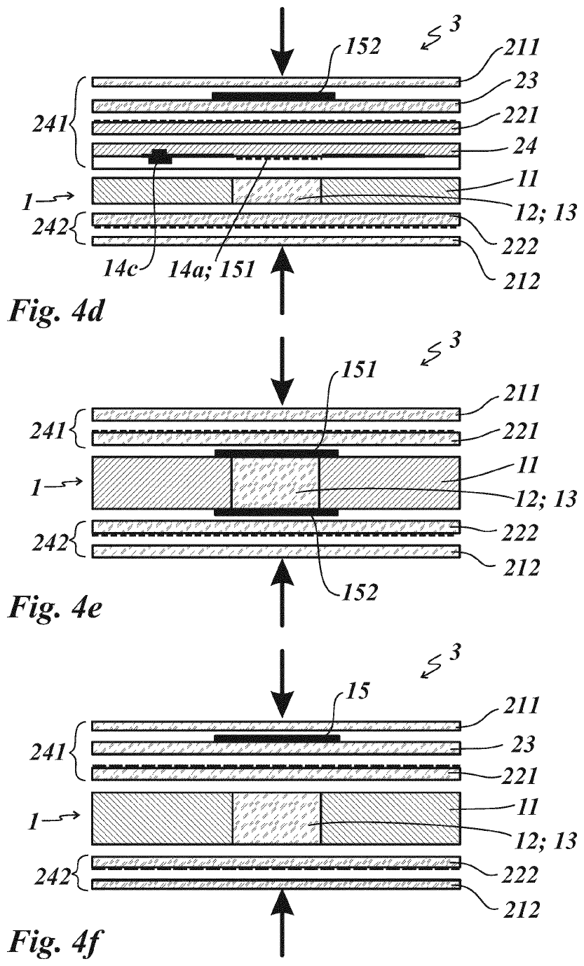

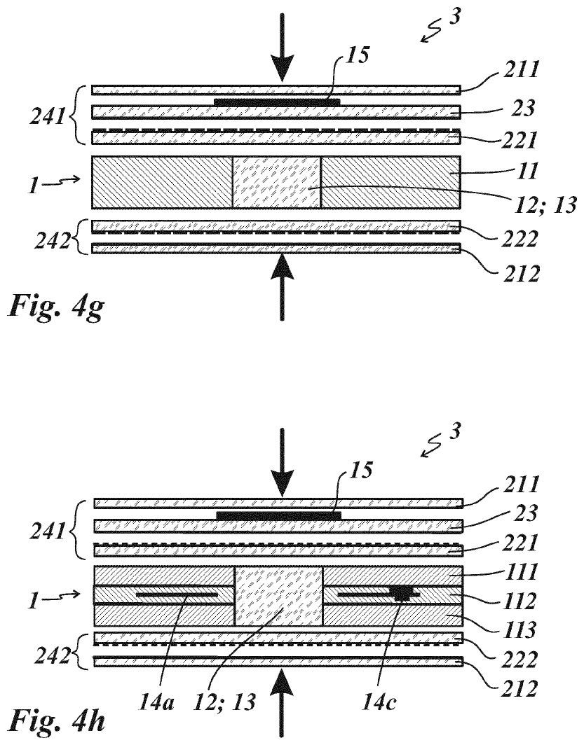

FIG. 4a shows a first embodiment example of a security document produced from the sheet according to the invention in a schematic sectional representation;

FIG. 4b shows the layer structure of the security document in FIG. 4a in a schematic sectional representation;

FIG. 4c shows the layer structure of a second embodiment example of a security document produced from the sheet according to the invention in a schematic sectional representation;

FIG. 4d shows the layer structure of a third embodiment example of a security document produced from the sheet according to the invention in a schematic sectional representation;

FIG. 4e shows the layer structure of a fourth embodiment example of a security document produced from the sheet according to the invention in a schematic sectional representation;

FIG. 4f shows the layer structure of a fifth embodiment example of a security document produced from the sheet according to the invention in a schematic sectional representation;

FIG. 4g shows the layer structure of a sixth embodiment example of a security document produced from the sheet according to the invention in a schematic sectional representation;

FIG. 4h shows the layer structure of a seventh embodiment example of a security document produced from the sheet according to the invention in a schematic sectional representation.

FIGS. 1 and 2 show a sheet 1, comprising an opaque carrier substrate 11 and n window elements 12 arranged in window openings 11a of the carrier substrate 11. In the embodiment example represented in FIG. 1 the number n of the window elements 12 is equal to 15. The window elements 12 are formed from a transparent window substrate 13.

As represented in FIG. 2, the surfaces of the carrier substrate 11 and of the window elements 12 are aligned with each other, with the result that the sheet 1 forms a uniformly shaped body.

The sheet 1 is formed as an opaque sheet with a substantially constant thickness, which contains transparent partial areas. The sheet 1 is a semi-finished product or an intermediate product for producing security documents 2, for example identity documents, data pages of passports, ID1 cards such as bank cards and access cards. Further layers and/or printings are applied to the sheet 1 by the producer of the security document 2, for example in order to personalize the security document 2 (see FIG. 4a to FIG. 4h). The sheet 1 has n sections which can in each case be completed to form a security document 2 and are delimited from each other by cutting lines. In the embodiment example represented in FIGS. 1 and 2, 15 security documents 2 can be produced from the sheet 1, which are obtained by separating or by punching out or by laser cutting of the sheet 1 formed with the further layers, for example, along or using the cutting lines. After this separation of the security documents, the separated security documents and the residual material are present as a grid. The carrier substrate 11 and the window substrate 13 consist of a thermoplastic from the group: polycarbonate (PC), polyvinyl chloride (PVC), acrylonitrile-butadiene-styrene (ABS) and polyethylene terephthalate (PET, PET-G). The opacity of the carrier substrate 11 is formed by means of fillers in the plastic, for example by pigments or dyes.

In order to form the sheet 1, the window openings 11a are formed in the carrier substrate 11, for example by
punching (with punch and die, closed punching knife, or similar);
cutting (knife, water jet, etc.);
lasers;
milling;
a chemical process.

The window elements 12 are produced from the window substrate 13 by
punching (with punch and die, closed punching knife, or similar);
cutting (knife, water jet, etc.);
lasers;
milling;

and, in a subsequent method step, are inserted into the window openings 11a of the carrier substrate 11.

In a further method step, the window elements 12 are joined to the carrier substrate 11 by lamination. The window elements 12 and the carrier substrate 11 thereby enter into a substance-to-substance bond which cannot be separated non-destructively. A softening temperature, which depends on the materials used, must be exceeded. In the case of polycarbonate, a temperature of approximately 150° C. must be exceeded and a surface pressure greater than 10 N/cm² must be applied. The lamination is carried out in a heated press, wherein the carrier substrate 11 fitted with the window elements 12 is laid between heated lamination plates which, when the press is closed, exert a pressing pressure on the carrier substrate 11 and the window elements 12, with the result that a sheet 1 with a constant thickness is formed. After the lamination, the sheet 1 has a thickness reduced by 5% to 10% relative to the unprocessed carrier substrate 11. On average, the thickness is reduced by approximately 8%. The loss of thickness results from the melting of different surfaces and the smoothing of the roughness of the starting materials typically used, and only to a very small extent from the flowing of the material in the press.

During lamination the surface roughness of the lamination plates is transferred to the surfaces of the sheet 1. The surface roughness of the sheet 1 is therefore determined by the surface roughness of the lamination plates. While solidifying in the cooling phase, the thermoplastic material takes on the surface roughness of the lamination plates used. It can also be provided, not only to adjust the surface roughness but also to form local surface structures and/or markings in the sheet 1 in a targeted manner.

Smooth surfaces are e.g. advantageous for a subsequent application of a hot stamping film to the sheet 1. This relates both to the behavior during the application procedure itself and to the lower degradation of the optical appearance in the case of subsequent lamination to form the end product. A surface area with a surface roughness of less than 0.3 μm is referred to here as a smooth surface.

A slightly increased surface roughness can e.g. improve the adhesion of the colors or the printing behavior during a subsequent printing process. Furthermore, a rough surface prevents several stacked layers from sticking together, which can occur in the case of smooth layers.

The surface roughness can be formed locally different, for example, smooth in areas with a KINEGRAM® and rough in surrounding areas.

It can also be provided to emboss a lens structure onto the window elements 12 and, in a further method step to stabilize these with a varnish for a subsequent lamination. The varnish and the material of the window elements 12 or the material of the lenses must have different optical properties, in particular different refractive indices, such that an optical effect of the lenses is retained. An optical boundary surface must thus be created in the form of a difference in refractive index of two adjoining materials. These can be adjacent plastics with a different refractive index and/or an in particular transparent reflective layer with a high refractive index (HRI layer; HRI—High Refractive Index).

As described further above, after lamination the thickness of the sheet 1 is generally reduced in comparison with the unprocessed carrier substrate 11.

However, it is also possible that the thickness of the sheet 1 relative to the unprocessed carrier substrate 11 is increased when the lamination plates have significant surface roughness.

The following lamination parameters have proved useful for the material polycarbonate:

Heating cycle: 150° C. to 210° C., 10 N/cm² to 300 N/cm², 1 min to 30 min

Cooling cycle: 20° C. to 50° C., 50 N/cm² to 800 N/cm², 1 min to 15 min

The position tolerances of the window openings in the sheet 1 depend on the production process of the opening, the lamination and the post-processing. As has been determined by means of tests, the following tolerances are preferably to be observed:

window opening 11a: +/−0.5 mm

lamination: +/−0.5 mm (The distortion can optionally be compensated for, if it is reproducible)

post-processing (edge trimming, position mark, position punching relative to the window openings 11a): +/−0.5 mm

total: +/−1.5 mm

The window openings 11a can be formed with minimum corner radii of 0.5 mm.

The size of the window opening 11a is limited on the one hand by the size of the security document 2 and on the other hand by the smallest producible window opening 11a. The term “size” refers to the surface area which, for example, in the case of rectangular window openings, corresponds to the product of width and height of the window opening 11a. As tests have shown, the size of the window opening 11a must be greater than 0.1 mm². The size of the window openings 11a preferably lies in the range of from 7 mm² to 700 mm².

Ideal window openings 1 a have a rectangular cross section with vertical cut edges. In this case the cut edges have an angle of inclination of 90° to the surface of the carrier substrate 11. The angle of inclination of the cut edges can lie in the range of from 60′ to 120°, preferably in the range of from 70° to 110°. The cross section can be formed trapezoidal or rhombic.

The thickness of the sheet 1 can lie in the range of from 30 μm to 750 μm, preferably in the range of from 100 μm to 600 μm.

FIG. 3a shows a second embodiment example of the sheet 1. The sheet 1 is formed like the sheet represented in FIG. 2, with the difference that the carrier substrate 11 is formed multilayered. The carrier substrate 11 has three layers. A first carrier substrate layer 111 and a third carrier substrate layer 113 are formed with a low opacity. A second carrier substrate layer 112 is formed as a layer with higher opacity and arranged between the first carrier substrate layer 111 and the third carrier substrate layer 113.

The three layers can advantageously be pre-stuck, for example by ultrasonic welding, thermal spot welding, partial or extensive gluing or a prelamination, such that, during the production of the window openings 1 a, the layers do not become displaced relative to each other. Different opacities of the individual layers can be adjusted, for example by means of fillers or dyes.

An example of several layers of the carrier substrate 11 can, for example, be a combination of a first ply of polycarbonate with pigments such as, for example, TiO₂, in order to achieve a white impression and a certain opacity, and a second ply of polycarbonate which is substantially transparent, but contains a further pigment, in order to be able to be simply blackened by means of a laser during personalization of the finished document.

FIG. 3b shows a third embodiment example of the sheet 1. The sheet 1 is formed like the sheet represented in FIG. 3a, with the difference that the window opening 11a is formed only in the second carrier substrate layer 112, with the result that the window element 12 is covered by the first carrier substrate layer 111 and the third carrier substrate layer 113, which are both formed as transparent layers or as layers with very low opacity.

FIG. 3c shows a fourth embodiment example of the sheet 1. The sheet 1 is formed like the sheet represented in FIG. 2, with the difference that the window opening 11a has a stepped cross section. Consequently, during observation of the sheet 1 from the front and from the back, different window contours are visible. The front of the sheet 1 lies at the top in the figures represented, the back at the bottom.

FIG. 3d shows a fifth embodiment example of the sheet 1. The sheet 1 is formed like the sheet represented in FIG. 2 with the difference that, in each section of the sheet 1, two window elements 12 are arranged which, in the embodiment example represented in FIG. 3d, have a different size and/or shape.

FIG. 3e shows a sixth embodiment example of the sheet 1. The carrier substrate 11 of the sheet 1 is constructed multilayered from two layers. A first window element 12a reaches through an upper first carrier substrate layer 111 and a lower second carrier substrate layer 112. The first carrier substrate layer 111 has a second window element 12b. During observation of the sheet 1 from the front and from the back, a different number of window elements is visible.

FIG. 3f shows a seventh embodiment example of the sheet 1. The sheet 1, like the sheet described further above in FIGS. 3a and 3b, has a carrier substrate 11 formed multilayered. The carrier substrate 11 comprises a first carrier substrate layer 111, a second carrier substrate layer 112 and a third carrier substrate layer 113. The second carrier substrate layer 112 arranged between the first carrier substrate layer 111 and the third carrier substrate layer 113 is formed as a functional layer 11f.

The functional layer 11f can have one or more electronic components, for example an RFID module, an RFID module with antenna, sensors (e.g. for a touch screen).

In the embodiment example represented in FIG. 3f, the functional layer 11f has an RFID module 14 with an RFID chip 14c and antennae 14a. The term RFID—radio-frequency identification—denotes transmitter-receiver systems for the automatic and contactless identification and/or localization of objects and/or living beings with radio waves. It can also be provided to dispense with a multilayer structure and to embed the RFID module 14 directly into the carrier substrate 11.

FIG. 3g shows an eighth embodiment example of the sheet 1. The sheet 1 is formed like the sheet described further above in FIGS. 1 and 2, with the difference that, on the front of the carrier substrate 11 laminated with the window elements 12, a functional layer 11f is arranged which, in the embodiment example represented in FIG. 3g, is laminated on and is formed as an optical filter which covers both the carrier substrate 11 and the window elements 12.

The functional layer 11f can be formed as follows:
the functional layer 11f has one or more electronic components, for example an RFID module, an RFID module with antenna, a display, sensors (e.g. for a touch screen in the window area and/or outside the window area), one or more LEDs.
the functional layer 11f has a printed alphanumeric and/or graphical item of information.
the functional layer 11f is formed as an optical filter (color, UV, IR, polarizer etc.).
the functional layer 11f has a stabilized surface texture, e.g. a kinoform. This means that a surface structure is filled with an additional layer with another refractive index, with the result that the optical effect is also retained in the case of a further lamination.
the functional layer 11f has partial metallizations.
the functional layer 11f is formed as a decorative film.
the functional layer if is formed as an EPD (electro phoretic display).
the functional layer 11f is formed as a diffractive optical element, such as for example a KINEGRAM®.

The second carrier substrate layer 112 which is shown and described, for example, in FIGS. 3a and 3b, can also be designed as such a functional layer 11f.

The window elements 12 can also be formed multilayered, as described further below, wherein the formation of the layers and of the layer structure can be provided analogously to the carrier substrate 11.

FIGS. 3h to 3v show further embodiment examples of the sheet 1, wherein the sheet comprises one or more KINEGRAMs®.

FIG. 3h shows a ninth embodiment example of the sheet. A sheet 1 has a window element 12 formed multilayered. Between a first window substrate layer 131 and a second window substrate layer 132, a KINEGRAM® 15 is arranged, which is extended over the whole window element 12.

FIG. 3i shows a tenth embodiment example of the sheet. A sheet 1 is formed like the sheet in FIG. 3h, with the difference that the KINEGRAM® 15 is extended only over a partial area of the window element 12.

FIG. 3k shows an eleventh embodiment example of the sheet. A sheet 1 is formed like the sheet in FIG. 2, with the difference that a KINEGRAM® 15, which covers the window element 12, is arranged on the window element 12.

FIG. 3l shows a twelfth embodiment example of the sheet. A sheet 1 is formed like the sheet in FIG. 3k, with the difference that the KINEGRAM® 15 is extended only over a partial area of the window element 12.

FIG. 3m shows a thirteenth embodiment example of the sheet. A sheet 1 is formed like the sheet in FIG. 3k, with the difference that the KINEGRAM® 15 also covers an edge area of the carrier substrate 11 adjoining the window element 12.

FIG. 3n shows a fourteenth embodiment example of the sheet. A sheet 1 is formed like the sheet in FIG. 3k, with the difference that the KINEGRAM® 15 is arranged asymmetrically with respect to the window element 12 and therefore does not completely cover the window element 12, but covers an edge area of the carrier substrate 11 facing away from the non-covered area of the window element 12.

FIG. 3o shows a fifteenth embodiment example of the sheet. A sheet 1 is formed like the sheet in FIG. 3n, with the difference that two KINEGRAM® 151 and 152, spaced apart from each other are provided, which cover opposite edge sections of the carrier substrate 11 or of the window element 12. The two areas 151 and 152 of the KINEGRAM® can also be parts of a single element which covers the circumferential edge of the window element 12 completely or almost completely, and has a transparent opening in the central area.

FIG. 3p shows a sixteenth embodiment example of the sheet. A sheet 1 is formed like the sheet in FIG. 3k, with the difference that, on the front of the sheet 1 a first KINEGRAM® 151 is arranged over the window element 12, and that on the back of the sheet 1 a second KINEGRAM® 151 is arranged over the window element 12.

FIG. 3q shows a seventeenth embodiment example of the sheet. A sheet 1 is formed like the sheet in FIG. 3p, with the difference that the window element 12 is formed multilayered from three window substrate layers, that the first KINEGRAM® 151 is arranged between the first window substrate layer 131 and the second window substrate layer 132, and that the second KINEGRAM® 152 is arranged between the second window substrate layer 132 and the third window substrate layer 133.

FIG. 3r shows an eighteenth embodiment example of the sheet. Both the carrier substrate 11 and the window element 12 of a sheet 1 are formed multilayered from two layers in each case. A KINEGRAM® 15 is arranged between the first and the second window substrate layer 131, 132, wherein it also covers edge areas of the first and of the second carrier substrate layer 111, 112 adjoining the window element 12.

FIG. 3s shows a nineteenth embodiment example of the sheet. A sheet 1 is formed like the sheet in FIG. 3r, with the difference that the KINEGRAM® 15 is arranged asymmetrically with respect to the window element 12 and therefore does not completely cover the window element 12, but covers an edge area of the carrier substrate 11 facing away from the non-covered area of the window element 12.

FIG. 3t shows a twentieth embodiment example of the sheet. A sheet 1 is formed like the sheet in FIG. 3s, with the difference that, in the case of a symmetrical arrangement, the first window substrate layer 131 is set back with respect to the second window substrate layer 132, wherein the KINEGRAM® 15 covers the second window substrate layer 132.

FIG. 3u shows a twenty-first embodiment example of the sheet. A sheet 1 is formed like the sheet in FIG. 3r, with the difference that the central axes of the two window substrate layers 131, 132 are offset with respect to one another.

FIG. 3v shows a twenty-second embodiment example of the sheet. A sheet 1 is formed like the sheet in FIG. 3q, with the difference that the carrier substrate is formed multilayered from three carrier substrate layers 111, 112, 113, and that the window element 12 has two window substrate layers 121, 122, which are arranged in window openings of the first carrier substrate layer 111 or of the third carrier substrate layer 113. The two KINEGRAMs® 151, 152 are arranged on both sides of the second carrier substrate layer 112, which is formed as a transparent layer.

FIG. 4a shows a first embodiment example of a security document 2 produced from the sheet 1 according to the invention. The sheet 1 is formed from polycarbonate and has a thickness of 410 μm.

On the front of the sheet 1, a first optical functional layer 221 is arranged, which is formed from polycarbonate and has a thickness of 100 μm. The first optical functional layer 221 is formed as a printed transparent layer. The printing can be thinned out in the area of the window element 12 or also entirely omitted in the area of the window element 12.

On the first optical functional layer 221, an optically variable functional layer 23 is arranged, which is formed from a transparent polycarbonate, has a thickness of 100 μm and is formed with a KINEGRAM® 15. The KINEGRAM® 15 is arranged over the window element 12 of the sheet 1. In this embodiment example, the KINEGRAM® 15 is a so-called KINEGRAM® REVIEWS, which, during observation of the front of the security document 2, shows a first KINEGRAM® and, during observation of the back of the security document 2, shows a second KINEGRAM®.

In order to form a KINEGRAM REVIEW®, a first KINEGRAM® Including partial metallization is produced. A replication varnish is again applied to the aluminum of the first KINEGRAM® and a second KINEGRAM® replicated. A second aluminum layer is then applied and a photosensitive varnish coated. This varnish is used for the second demetallization. Here, the partial metallization of the first KINEGRAM® serves as a mask during the UV exposure of the photosensitive varnish. Following the exposure, the photosensitive varnish is developed and the areas of the second aluminum layer which are no longer covered with the protective photosensitive varnish, are removed. The partially metallized KINEGRAM® visible from the back is thus arranged in perfect register to the KINEGRAM® visible from the front

On the optically variable functional layer 23, a first protective layer 211 is arranged, which is formed from a transparent polycarbonate and has a thickness of 50 μm.

On the back of the sheet 1, a second optical functional layer 222 is arranged which is formed like the first optical functional layer 221.

On the second optical functional layer 222, a second protective layer 212 is arranged, which is formed like the first protective layer 211. FIG. 4b shows a layer structure 3 for producing the security document 2 represented in FIG. 4a. Before the lamination, the layers 211, 23 and 221 arranged on the front of the sheet 1 are assembled to form a first lamination package 241, likewise the layers 222 and 212 arranged on the back of the sheet 1 are assembled to form a second lamination package 242, with the result that all the layers and the sheet 1 are arranged in register. The assembly takes place, for example, by means of an adjustment aid and by spot-sticking of the plies by means of ultrasound.

FIG. 4c shows the layer structure of a second embodiment example of a security document 2 produced from the sheet 1 according to the invention. The layer structure 3 is formed like the layer structure represented in FIG. 4b, with the difference that the carrier substrate 11 is formed as a functional layer 11f which comprises an RFID chip 14c and an antenna 14a. The sheet 1 is formed from polycarbonate with a thickness of 490 μm.

The optically variable functional layer 23 has a KINEGRAM® 15 formed as a KINEGRAM® RECOLOR. In the case of the KINEGRAM® RECOLOR, a dyed etch-resist varnish is used for the partial metallization. The etch-resist varnish is dyed and printed onto the aluminum. The printed etch resist protects the aluminum and thus provides the partial metallization, whereby the color is then in perfect register to the metallic area of the KINEGRAM® that is visible from the front. When observed from the back, a dyed KINEGRAM® is visible.

FIG. 4d shows the layer structure 3 of a third embodiment example of a security document 2 produced from the sheet 1 according to the invention.

The sheet 1 is formed from polycarbonate with a thickness of 190 μm and has a structure as described further above in FIGS. 1 and 2.

On the front of the sheet 1, a combined functional layer 24 with a layer thickness of 270 μm is arranged. The combined functional layer 24 comprises a first KINEGRAM® 151, i.e. an optically variable element, which forms a freeform antenna 14a, and an RFID chip 14c, i.e. an electronic element. By means of freeform antennae 14a, customer-specific designs can be produced as an antenna track. The window elements 12 of the sheet 1 make it possible to make the area of the freeform antenna 14a in the security document 2 visible on one side (on the back in the embodiment example represented in FIG. 4d).

On the combined functional layer 24, a first optical functional layer 221 made of a white-dyed polycarbonate with a thickness of 100 μm is arranged. The optical information is formed as printing.

On the first optical functional layer, an optically variable functional layer 23 made of transparent polycarbonate with a thickness of 100 μm is arranged, which is formed with a second KINEGRAM® 152. The second KINEGRAM® 152 is in each case at least partially arranged over the assigned window element 12 of the sheet 1.

In a particular design, that area into which a photo of the document owner is introduced, for example by personalization by means of a laser, lies between the freeform antenna on the back and the KINEGRAM® on the front. The personalization is thereby protected from manipulation from both sides. In addition, the printing in the area of the photo is typically very largely omitted in order to impair the recognition of the personalization as little as possible.

On the first optical functional layer 221, a first protective layer 211 is arranged, which is formed from transparent polycarbonate with a thickness of 50 μm.

The above-named four layers 24, 221, 23 and 211 form a first lamination package 241.

On the back of the sheet 1, a second optical functional layer 222 is arranged which is formed analogously to the optical functional layer 221, but with a transparent ply made of polycarbonate.

On the second optical functional layer 222, a second protective layer 212 is arranged, which is formed like the first protective layer 211.

The above-named two layers 222 and 212 form a second lamination package 242.

FIG. 4e shows the layer structure 3 of a fourth embodiment example of a security document 2 produced from the sheet 1 according to the invention.

Both on the front and on the back, the sheet 1 has a KINEGRAM® 151, 152 which is arranged in each case over the window element 12 of the sheet 1. The sheet 1 is formed from polycarbonate with a thickness of 410 μm. The two KINEGRAMs® 151, 152 are applied to the carrier substrate 11 or to the window element 12 before the lamination of the sheet 1.

As the two KINEGRAM® 151,152 are arranged at a defined distance, they can interact and thereby produce optical effects in transmitted light. It can also be provided to arrange a KINEGRAM® on one side only, and/or a printing and/or a partially metallized film on the other side. However, it can also be provided to apply a partially metallized film and/or printing to both sides.

The thickness of the sheet 1 and thus the distance between the two KINEGRAM® 151, 152 can vary depending on the optical effect to be achieved. A preferred distance lies in the range of from 30 μm to 500 μm, further preferably in the range of from 50 μm to 250 μm.

A printed transparent first optical functional layer 221 made of polycarbonate with a thickness of 100 μm is arranged on the front of the sheet 1.

A first protective layer 211 made of transparent polycarbonate with a thickness of 100 μm is arranged on the first optical functional layer 221. The above-named two layers 221 and 211 form a first lamination package 241.

On the back of the sheet 1, a second optical functional layer 222 is arranged, which is formed like the first optical functional layer 221.

On the second optical functional layer 222, a second protective layer 212 is arranged, which is formed like the first protective layer 211.

The above-named two layers 222 and 212 form a second lamination package 242.

FIG. 4f shows a layer structure 3 of a fifth embodiment example of a security document 2 produced from the sheet 1 according to the invention.

A layer structure 3 is formed like the layer structure represented further above in FIG. 4b, with the difference that both the sheet 1 and the layers applied to the sheet 1 are formed from polyvinyl chloride.

In the case of a high surface coverage of the printing inks of the optical functional layers 221 and 222, the side of the adjacent layer opposite the printing can be coated with an adhesive in order to achieve a better adhesion. Polyester, acrylates or dissolved PVC are possible as adhesives.

FIG. 4g shows a layer structure 3 of a sixth embodiment example of a security document 2 produced from the sheet 1 according to the invention.

The layer structure 3 is formed like the layer structure represented further above in FIG. 4b, with the difference that the sheet 1 and the layers applied to the sheet 1 are formed from different materials.

The sheet 1 and the optical functional layers 211 and 212 are formed from polyvinyl chloride (PVC). The optically variable functional layer 23 and the protective layers 211 and 212 are formed from polycarbonate as this material has a higher resistance than polyvinyl chloride. On the other hand, polyvinyl chloride is more cost-effective than polycarbonate. Further material combinations with materials such as PET-G, PET, Teslin® etc. are possible. Teslin® is the trade mark for a printing medium of matte, white, uncoated, single-ply polyethylene film.

In the case of a high surface coverage of the printing inks of the optical functional layers 221 and 222, the side of the adjacent layer opposite the printing can be coated with an adhesive in order to achieve a better adhesion. Polyester, acrylates or dissolved PVC are possible as adhesives.

FIG. 4h shows a layer structure 3 of a seventh embodiment example of a security document 2 produced from the sheet 1 according to the invention.

The layer structure 3 is formed like the layer structure represented further above in FIG. 4b, with the difference that the sheet 1 is formed multilayered as described further above in FIG. 3f, wherein the two outer carrier substrate layers 111 and 113 of the sheet 1 and the layers applied to the sheet 1 are formed from PVC.

The first carrier substrate layer 111 and the third carrier substrate layer 113 are formed from opaque PVC with a thickness of 220 μm and coated with an adhesive on the side facing the second carrier substrate layer 112. The adhesive can be formed from polyester, acrylate or dissolved PVC.

The second carrier substrate layer 112 having an RFID chip 14c with antenna 14a is formed from polyethylene with a thickness of 50 μm. Unlike the schematic representation in FIG. 4b, the second carrier substrate layer 112 is fitted on both sides with antenna tracks and chips.

### LIST OF REFERENCE NUMBERS

1 sheet
2 security document
3 layer structure
11 carrier substrate
11a window opening
11f functional layer
12 window element
12a first window element
12b second window element
13 window substrate
14 RFID module
14a antenna of the RFID module
14c RFID chip
15 KINEGRAM®
21 protective layer
22 optical functional layer
23 optically variable functional layer
24 combined functional layer
25 electronic functional layer
111 first carrier substrate layer
112 second carrier substrate layer
113 third carrier substrate layer
131 first window substrate layer
132 second window substrate layer
133 third window substrate layer
211 first protective layer
212 second protective layer
221 first optical functional layer
222 second optical functional layer
231 first optically variable functional layer
241 first lamination package
242 second lamination package

1. A sheet for forming a security document, comprising a carrier substrate and n window elements arranged in window openings of the carrier substrate, wherein n is at least equal to 1 and wherein the n window elements are formed from a transparent window substrate and wherein the n window elements are substance-to-substance bonded to the carrier substrate.

2. The sheet according to claim 1, wherein a continuous transition is formed between the surfaces of the n window elements and the surface of the carrier substrate.

3. The sheet according to claim 1, wherein the front and/or the back of the sheet are or is formed with a surface roughness of less than 0.3 μm.

4. The sheet according to claim 1, wherein the front and/or the back of the sheet are or is formed with a surface roughness greater than 0.3 μm.

5. The sheet according to claim 1, wherein the front and/or the back of the sheet are or is formed with a different surface roughness in some areas.

6. The sheet according to claim 1, wherein the front and/or the back of the sheet are or is formed with a surface embossing at least in some areas.

7. The sheet according to claim 6, wherein the sheet comprises window elements, the front and/or the back of which are or is formed with a lens structure.

8. The sheet according to claim 1, wherein the front and/or the back of the sheet are or is formed with markings.

9. The sheet according to claim 1, wherein the carrier substrate and the window substrate are formed from the same thermoplastic material.

10. The sheet according to claim 1, wherein the carrier substrate and the window substrate are formed from different plastic material.

11. The sheet according to claim 1, wherein the carrier substrate and/or the window substrate are or is formed from polycarbonate, polyvinyl chloride, acrylonitrile-butadiene-styrene, polyethylene or polyethylene terephthalate.

12. The sheet according to claim 1, wherein the carrier substrate is formed opaque by means of fillers.

13. The sheet according to claim 12, the fillers are formed as pigments and/or as dyes.

14. The sheet according to claim 1, wherein the carrier substrate is formed multilayered.

15. The sheet according to claim 14, wherein the carrier substrate is formed from layers with different opacity, wherein at least two layers have a different opacity.

16. The sheet according to claim 14, wherein the carrier substrate has at least one functional layer.

17. The sheet according to claim 16, wherein the at least one functional layer comprises an RFID module.

18. The sheet according to claim 1, wherein the window substrate is formed multilayered.

19. The sheet according to claim 18, wherein the window substrate is formed from layers with different transparency, wherein at least two layers have a different transparency.

20. The sheet according to claim 18, wherein the window substrate has at least one functional layer.

21. The sheet according to claim 20, wherein the at least one functional layer comprises a hologram.

22. The sheet according to claim 1, wherein at least one further layer is laminated onto the carrier substrate and/or the window element.

23. The sheet according to claim 1, wherein the sheet has a thickness in the range of from 30 μm to 750 μm.

24. A method for producing a sheet for forming a security document, comprising a carrier substrate and n transparent window elements arranged in the carrier substrate with an n-th outer edge contour, wherein n is at least equal to 1, wherein the following method steps are provided:
a) providing the carrier substrate which is formed from a thermoplastic material which has a melt phase;
b) forming an i-th window opening with an i-th inner edge contour which is congruent with an i-th outer edge contour of an i-th window element, in the carrier substrate;
c) providing a window substrate which is formed from a thermoplastic material which has a melt phase;
d) forming the i-th window element;
e) inserting the i-th window element into the i-th window opening;
f) repeating method steps b) to e) up to i=n in order to form the sheet;
g) placing the sheet in a laminating press, wherein a temperature and a pressing pressure can be formed in the laminating press, and laminating the sheet at a temperature above the melt phases of the carrier substrate and of the window substrate.

25. The method according to claim 24, wherein the laminating press has an upper stamp and/or a lower stamp which are or is formed as an embossing stamp at least in some areas.

26. The method according to claim 24, wherein method steps a) and b) and method steps c) and d) are performed independently of each other.

27. The method according to claim 24, wherein the carrier substrate and the window substrate are formed from the same thermoplastic material.

28. The method according to claim 24, wherein the carrier substrate and the window substrate are formed from different plastic material.

29. The method according to claim 24, wherein the carrier substrate and/or the window substrate are or is formed from polycarbonate, polyvinyl chloride, acrylonitrile-butadiene-styrene, polyethylene or polyethylene terephthalate.

30. The method according to claim 24, wherein the carrier substrate is formed opaque.

31. The method according to claim 30, wherein the opacity of the carrier substrate is formed by means of fillers.

32. The method according to claim 31, wherein pigments and/or dyes are used as fillers.

33. The method according to claim 24, wherein the carrier substrate is formed multilayered.

34. The method according to claim 33, wherein the carrier substrate is formed from layers with different opacity, wherein at least two layers have a different opacity.

35. The method according to claim 33, wherein at least one layer of the carrier substrate is formed as a functional layer.

36. The method according to claim 35, wherein the at least one functional layer comprises an RFID module.

37. The method according to claim 24, wherein the window substrate is formed multilayered.

38. The method according to claim 37, wherein the window substrate is formed from layers with different transparency, wherein at least two layers are formed with a different transparency.

39. The method according to claim 37, wherein at least one layer of the window substrate is formed as a functional layer.

40. The method according to claim 39, wherein the at least one functional layer comprises a hologram.

41. The method according to claim 24, wherein, before method step g), at least one further layer is applied to the carrier substrate and/or the window element.

42. The method according to claim 24, wherein the sheet is formed with a thickness in the range of from 30 μm to 750 μm.

43. A security document wherein the security document comprises a sheet according to claim 1.
